(19) United States
(12) Patent Application Publication
(10) Pub. No.: US 2009/0124530 A1
(43) Pub. Date: May 14, 2009

(54) Process to form fabric softening particle, particle obtained and its use

(76) Inventors: Renee Boerefijn, Vlaardingen (NL); Sander Bas Kluit, Vlaardingen (NL); Vidyadhar Sudhir Ranade, Utrecht (NL); Harmannus Tammes, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/989,052

(22) PCT Filed: Jul. 6, 2006
(86) PCT No.: PCT/EP2006/006698

§ 371 Date: Jul. 17, 2008

(30) Foreign Application Priority Data
Jul. 19, 2005 (GB) 0514716.0

(51) Int. Cl. C11D 3/37

(52) U.S. Cl. 510/327; 510/515

(57) ABSTRACT

This invention relates to the incorporation of single and double emulsions into a cross-linking polysaccharide matrix selected from alginate and carrageenan, particularly when cured in a saline solution. Beading and extrusion were used as encapsulation processes. Particles were obtained containing 54 to 88% oil. The double emulsion is known to deliver rinse conditioner softness to the wash. The problem has been to incorporate it into a matrix that will allow redispersion in the wash. The emulsions incorporated redisperse in the same manner as they did before incorporation. The technology has been tested for a wide range of oils, however, specific combinations of oils and kappa carrageenan yield excellent particles containing high oil levels, which are suitable for incorporation into detergent powders, with good softening performance.

This invention relates to a process to form fabric softening particles capable of delivering softening oil to laundry wash liquor, to the fabric softening particles obtainable by the process, to a laundry detergent composition including the fabric softening particles and to use of such a composition.

Repeated laundering of clothes results in fabric harshening, which may be countered by addition of a separate rinse conditioner. However, the convenience of a single product that delivers both cleaning and conditioning holds great appeal. This so-called “softening in the wash” is a long-standing goal of detergent manufacturers and, although many approaches have been tried, none has succeeded in matching the softness delivery of a separate rinse conditioner. Typically, 2-in-1 powder compositions deliver only about half the softness of a separate rinse conditioner composition.

Delivery of improved softness from the main wash may be achieved by targeted deposition of silicone oil to cotton surfaces using the delivery aid cellulose monoacetate (CMA), as described in WO 00 18861. However, it is a problem to scale up emulsification and granulation of this technology in a reproducible manner and at an affordable cost.

WO 03049846 describes a process for forming double emulsion particles that could be useful for delivery of modified polysaccharides such as CMA or silicone graft CMA. A problem with double emulsions of this type is that it is very difficult to granulate them to make them suitable for inclusion in a powdered detergent formulation. In particular they are difficult to dry at large scale.

For the purpose of this specification a double emulsion, or ‘duplex’, is an emulsion of the water/oil/water configuration.

It is a known problem to control the size distribution of a softening oil upon introduction into the wash, as it is believed that larger oil droplet sizes do not deliver softness. This means that during the process of making a softening particle the oil droplets should not agglomerate or coalesce to any significant extent.

According to the present invention there is provided a process for making a softening particle comprising softening oil in a polymer matrix, characterised in that the process includes the steps of:
(a) forming a single or double emulsion comprising the softening oil and water
(b) dispersing the emulsion in a weight excess of polysaccharide comprising linked anhydroglucose type units having an average degree of sulphation of less than 0.6 per unit
(c) cross-linking or gelling the polysaccharide with an aqueous solution of cations to form the polymer matrix.

Advantageously the cations comprise potassium, most advantageously from a solution of potassium chloride. Potassium is not normally present in large quantities during a laundry process, whether from the detergent formulation, or from the water, or from the soiled laundry. Thus the potassium can dissolve in the dilute wash liquor and thereby allow the matrix to release the softening oil into the wash liquor.

This process may be considered to provide a matrix by causing the specified polysaccharides to gel. We have found that to obtain the best gel formation it is desirable to keep the temperature below 60° C. during each of steps a, b and c.

The preferred polysaccharides for the process are kappa carrageenan or alginate, kappa carrageenan being most preferred, especially if it will not be used with sequestrants.

Carrageenan, a mixture of water-soluble, linear, sulphated galactans, is the generic name for a family of gel-forming, viscosifying polysaccharides that are obtained commercially by extraction from certain species of red seaweed. There are several idealised types of carrageenan of which iota, lambda and kappa are common.

Kappa carrageenan has the ability to form a gel on cooling of a hot solution. According to the literature, the gel forms due to double-helix formation. At temperatures higher than the melting point of the gel, thermal agitation overcomes the tendency to form helixes and the polymer only exists in solution as a random coil. On cooling, a three-dimensional polymer network builds up again to form a gel. Increasing the concentration of kappa carrageenan in the solution causes an increase of viscosity. To obtain a high viscosity with low concentrations of kappa carrageenan, cations need to be present. Kappa carrageenan will not gel in the presence of Na⁺, but will in the presence of K⁺, Ca²⁺ or NH⁴⁺, with potassium producing the strongest gel. A gel-like structure will be formed in the presence of excess Na⁺, but a useful, coherent gel is not produced. The gelling temperature of kappa carrageenan is relatively insensitive to the concentration of the carrageenan in the solution and is primarily a function of the amount of cations present. The mechanism of the gelling of kappa carrageenan with cations may be described as follows: The higher the 3,6-anhydrogalactose (DA-unit) content of the kappa carrageenan, the greater the enhancement of gel strength by gelling cations. This may be explained by the increased hydrophobicity imparted to the polymer by the DA-unit, plus the lower solubility of potassium salt, since according to one theory of gelation, gel formation is looked upon as a type of precipitation. Other contributing factors are the increased regularity of the polymer, leading to an increase of helical content and improved ion packing.

Iota carrageenan also binds water, but forms a dry, elastic gel, especially in the presence of calcium salts. The divalent calcium ions help form bonds between the carrageenan molecules to form helices. The 2-sulphate group on the outside of the ι-carrageenan molecule does not allow the helices to aggregate to the same extent as kappa carrageenan. However, the sulphate groups do form additional bonds through calcium interactions. Iota carrageenan is soluble in hot water and the sodium variant is soluble in cold and hot water. Iota carrageenan is not very suitable for use in the present invention due to the amount of sulphate groups it contains.

Alginate is a naturally occurring polysaccharide extracted from brown seaweed. It comes from a family of unbranched binary copolymers and consists of (1→4) linked α-L-guluronic (G) and β-D-mannuronic (M) acid residues. Alginate occurs in different conformations and due to its ability to form a network with divalent cations; it varies in rheological and functional properties.

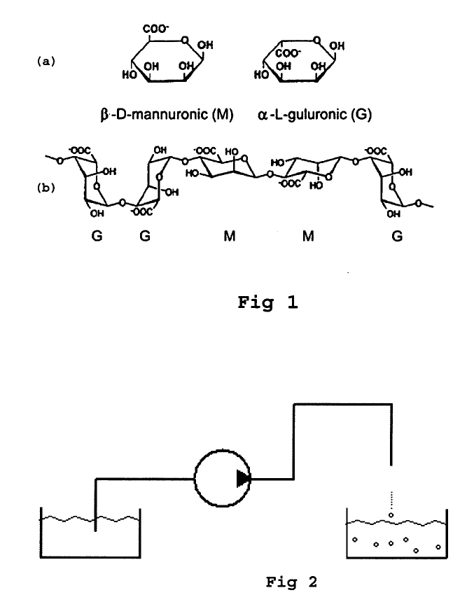

Depending on the source of the alginate, the molecules can be composed of three types of blocks: polymannuronic acid blocks (MM), polyguluronic acid blocks (GG) and mixed blocks (MG) (FIG. 1). Because alginate is derived from a natural source, the amount of each component (M and G) varies with the source of the alginate. The level of these acid blocks are important for gel-strength, especially the level of G. This has to do with the gel forming capacities of alginate with divalent cations, especially with that of Ca²⁺ ions. It can be generally stated that the higher the level of guluronic acid in the alginate, the greater the affinity for Ca²⁺ ions, which leads to more robust gels. Therefore the molecular weight distribution can have implications for the uses of alginates, as low-molecular-weight fragments containing only short G-blocks may not take part in gel-network formation and consequently do not contribute to gel strength.

An advantage of carrageenan over alginate is that the cation binding is reversible. This means that when an e.g. kappa carrageenan gel is placed in an excess of water, the cation will diffuse from the gel into the water, which then results in dissolution of the gel. However, if there are suitable sequestrants in the water, it is possible to create a similar effect with the alginate. Obviously when alginate gels are used with laundry detergent compositions that contain sequestrants and/or builder compounds the desired reversible gelling will be obtained.

The softening oil is emulsified and may be in the form of either a single or a double emulsion. Whist the softening oil may be any type, preferred softening oils are selected from the group comprising those that form single emulsions such as mineral oil; sunflower oil; silicon oil, especially amino-functional silicone oils such as Rhodorsil Oil ExtraSoft supplied by Rhodia Silicones (ExtraSoft); medium chain triglyceride (MCT) oil as well as those that can be formed as double emulsions, such as silicone oil. Other silicones may be selected from those disclosed in GB 1,549,180A, EP 459,821A2 and EP 459,822A. These silicones can also be used as lubricants. Other suitable lubricants that could be used in this invention include any of those known for use as dye bath lubricants in the textile industry. In this specification the expression softening oil includes, in its broadest embodiment, a softening oil which has been grafted, or otherwise attached, to a non-hydrolysable cellulose substantive polysaccharide, especially cellulose monoacetate (CMA) or locust bean gum (LBG). Such materials are described, for example, in the abovementioned WO2000/018861 and in WO2004/111169.

SEM images for kappa carrageenan indicate better packing of double emulsion droplets when emulsion concentration is increased. Preferably, the emulsion has an oil level of more than 50%, more preferably more than 60%, most preferably more than 70% by weight. The upper limit for the oil level is set by the practical limitations of the system and will be about 90 wt %.

Also, according to a second aspect of the invention there is provided a dried softening particle with a mean diameter of less than 1000 micron, preferably less than 700 micron, most preferably less than 650 micron. Advantageously it has a mean diameter of more than 250 micron, more advantageously more than 400 micron and most advantageously more than 450 micron. Preferably, the particles have a water content of from 3 to 20 wt %, more preferably 4 to 15 wt % and most preferably 5 to 10 wt %. Such particles are obtainable by the process according to the first aspect of the invention. The particles advantageously comprise at least 50 wt % of softening oil in a matrix of kappa carrageenan or alginate. Softening particles with oil levels as high as 90% may be obtained using the process.

An extrusion or a beading process may be used to obtain such a particle.

Preferably, the matrix material is kappa carrageenan if the particle is to be used in a system without sequestrants. Alginate matrix material is also preferred if a sequestrant and/or builder is present in the formulation into which the softening particle is introduced and used.

Advantageously the softening oil comprises a double emulsion. SEM images show a thicker wall between oil droplets in alginate compared to kappa carrageenan samples, this impairs the dispersion of the oil and reduces the amount of oil that may be carried in the particle.

A third aspect of the present invention is a detergent powder, or liquid, or tablet, containing 1 to 7 wt % of softening particles made according to the process of the invention. Preferably, the level is 1 to 5 wt %, most preferably it is 2 to 3 wt %.

The invention also contemplates the use of an effective amount of this detergent composition to soften fabric in the wash, especially when the fabric comprises cotton.

An advantage of use of this type of polysaccharide is that low carrier levels are required compared to standard technologies (e.g. spray drying, granulation). In-wash softening materials need to be added at the level of several percent of total formulation. The percentage of softening particles in the formulation can be kept lower by using the particles according to this invention.

The examples investigate the use of Alginate and Carrageenan for encapsulating double emulsions containing various softening oils. Evaluation of the quality of these encapsulates using carrageenan and alginate is done by quantification of the dispersion behaviour of oil droplets in wash liquor. Two tests were also conducted using consumer sensory tests to measure softness. To show the applicability of the invention several types of oil were also incorporated as single emulsions. The types of oils chosen for this embodiment of the process varied from low viscosity to high viscosity and the overall structure of the oil also varied.

Examples used iota and kappa carrageenan and alginates. Several types of kappa carrageenan and one type of iota carrageenan were used. Potassium chloride (1M solution) was used for curing (gelling) of the kappa carrageenan samples and a calcium chloride solution (1M) was used for the curing of the alginate and iota carrageenan samples. Table 1 gives some properties of the polysaccharides used. The M and G in the table represent the percentages of respectively mannuronic acid (M) and guluronic acid (G) in the alginate.

TABLE 1
Polysaccharides used

| | Grade/ | | T_{gel} | | |
|---|---|---|---|---|---|
| Polysaccharide | Manufacturer | viscosity | [° C.] | M | G |
| kappa- | X0909/CP Kelco | high | <20 | — | — |
| carrageenan | | | | | |
| kappa- | TS599/CP Kelco | high | 38 | — | — |
| carrageenan | | | | | |
| kappa- | TS-C 6244/ | middle | 42 | — | — |
| carrageenan | Danisco | | | | |
| iota- | Sigma Aldrich | high | — | — | — |
| carrageenan | | | | | |
| alginate | Manucol DH/ISP | low | <20 | 70 | 30 |
| alginate | Manugel GMB/ISP | high | <20 | 30 | 70 |

### Processes

Two processes were investigated for producing granules from double emulsions: extrusion and bead making.

First, the duplex emulsion was mixed with the polysaccharide using an IKA Eurostar top-mixer. Then, for extrusion, the mixture was injected into a bath containing a gelling/curing solution, whereas for bead making the apparatus shown schematically in FIG. 4, was used. The process used for bead making used a pump that transported the mixture of polysaccharide and double emulsion through a nozzle, from which drops fell into the gelling/curing solution to form bead particles.

The noodles and beads obtained from the processes were dried in a Retsch TG-1 fluidised bed for 30 minutes at 60° C. Single emulsions were made by mixing 5 ml 0.15% Synperonic F108; 21 ml demineralised water and 24 ml softening oil at 1000 rpm in a turbine mixer for 5 minutes. This was followed by mixing the emulsion formed with 50 g of a 5% kappa carrageenan solution (X0909, CPKelco) or a 5% solution of alginate (GMB or DH) using a turbine mixer at 1000 rpm for 10 minutes. Using this process single emulsions were made from Mineral oil; Sunflower oil; Silicon oil (ExtraSoft); and Medium Chain Triglyceride (MCT) oil.

The single emulsions mixed with kappa carrageenan were also used for bead making in the same manner as for the double emulsions. Particles obtained were analysed for powder moisture content (PMC) using an IR Balance and the effectiveness of dispersion of the particles in a detergent wash-liquor at 40° C. was measured using a Malvern 2600LBD optical laser. Softness tests were performed on washed samples of cloth by a standard type of paired comparison panel test. A Scanning Electron Microscope (SEM) was also used to obtain a record of the structure of the particles.

Dispersion of oil from the particles was measured using a Malvern. The solution into which the particles were dissolved at 40° C. was a full powder based built detergent formulation used at a wash liquor concentration of 6.8 g/litre. Dispersion was measured at three stages: the full mix of emulsion with carrageenan, a ‘wet’ particle and a dried particle. Dried particles were obtained after drying the wet particles for 30 minutes at 60° C. using a Retsch TG-1. PMC was determined in order to calculate oil- and polysaccharide levels of the dried particles.

### Results for Double Emulsion

It was not possible to obtain a noodle or particle from iota-carrageenan. Possibly, because the coils of iota-carrageenan did not cross-link well enough to provide the strength needed for a coherent structure.

Kappa carrageenan and alginate softening particles were obtained with differing oil: polysaccharide matrix ratios as shown in table 2. The water-content was determined using an infrared balance (Mettler Toledo LJ16). Polysaccharide and oil levels were calculated based on the materials used.

TABLE 2
Characteristics of softening particles

| | | Poly- | | | Process |
|---|---|---|---|---|---|
| Polymer & | Water | saccharide | | type of | temperature |
| grade | [%] | [%] | Oil [%] | process | [° C.] |
| Alginate | | | | | |
| GMB | 13.0 | 7.82 | 74.49 | Beading | 20 |
| DH | 10.0 | 20.87 | 64.44 | Extrusion | 20 |
| kappa | | | | | |
| carrageenan | | | | | |
| TS-C 6244 | 4.0 | 7.76 | 83.54 | Extrusion | 60 |
| TS599 | 10.0 | 15.93 | 69.38 | Extrusion | 60 |
| X0909 | 4.0 | 6.81 | 84.50 | Extrusion | 60 |
| X0909 | 8.0 | 33.13 | 54.18 | Beading | 20 |
| X0909 | 5.0 | 8.60 | 81.71 | Beading | 20 |

### Dispersion Measurements

A suitable matrix material will release the encapsulated emulsion in such a way that the emulsion is delivered with substantially the same droplet size distribution as it had before encapsulation. In order to investigate this, the D(v0.5) and D(v0.9) were measured. D(v0.5) is the value where 50% of the total volume of the emulsion is made up of drops with diameters larger than the median value and 50% smaller than the median value. D(v0.9) is the value where 90% of the total volume of the emulsion is made up of drops with diameters smaller or equal to this value. Results from Malvern dispersion measurements of these values are given in table 3.

TABLE 3
Results from Dispersion Measurements

| | EX | Type | Format | State | Oil [%] | D_{(v, 0.5)} | D_{(v, 0.9)} |
|---|---|---|---|---|---|---|---|
| Emulsion | | 04AGT0 | — | liquid | | 14.0 | 20.6 |
| | | 33 | | | | | |
| Poly- | 1 | X0909 | blend | liquid | 81.71 | 11.7 | 17.3 |
| saccharide | 2 | X0909 | bead | cured/not | 81.71 | 11.5 | 16.8 |
| kappa | | | | dried | | | |
| carrageenan | 3 | X0909 | bead | dried | 81.71 | 11.9 | 19.0 |
| | 4 | X0909 | noodle | dried | 81.71 | 8.4 | 11.8 |
| | 5 | X0909 | noodle | processed | 81.71 | 26.2 | 112.8* |
| | | | | at 60° C. | | | |
| | 6 | X0909 | bead | dried | 54.18 | 8.4 | 11.8 |
| | 7 | X0909 | noodle | dried | 84.50 | 9.3 | 14.3 |
| | 8 | TS-C | noodle | dried | 83.54 | 14.4 | 30.7 |
| | | 6244 | | | | | |
| | 9 | TS599 | noodle | dried | 69.38 | 13.9 | 26.8 |
| Alginate | 10 | DH | noodle | dried | 64.44 | 6.8 | 10.4 |
| | 11 | DH | chopped | dried | 64.44 | 8.7 | 24.3 |
| | | | noodle | | | | |
| | 12 | GMB | bead | dried | 74.49 | 12.1 | 24.0 |

*The distribution of this sample exceeds 200 μm, which is too large to be measurable with the lens.

Most of the kappa carrageenan examples re-dispersed the emulsion with the same behaviour as the original emulsion. The variation between the samples was probably mainly caused by mixing. Agglomeration of the oil droplets did not occur, except for the sample that was produced at 60° C. All other examples do not seem to be influenced by the way they are produced. For examples 1 to 3, there is no change in emulsion droplet size between the blend state, the curing state and after drying. The agglomeration of oil droplets that occurs in example 5 was probably caused by the instability of the emulsion at that temperature. This is underlined when comparing the results from example 5 (heated) with those of sample 1 (non-heated). Comparing examples 6 and 7 shows that the level of oil incorporation does not influence the re-disperseability. A clear difference between granules obtained from noodles and from beads was not found.

There were no residues left after the tests were finished.

The examples made from alginate show similar behaviour. The differentiator between the types of alginate is molecular weight and the capacity to cross link with Ca²⁺. The increase in droplet size for the GMB sample might be caused by the high molecular weight of the sample, i.e. there is a different packing behaviour, when compared to the low molecular weight (Mwt) sample. High Mwt possibly causes larger ‘pockets’ for the oil droplets to house in comparison to the low Mwt sample.

It was also observed that after the dispersion test was terminated, there were alginate residues found, still containing oil. This was probably caused by the irreversibility of the Ca²⁺ cross-linking. The sequestrant present in the detergent solution is not strong enough to ‘pull-off’ the calcium-ions from alginate, resulting in poor dissolution of the example. Like the carrageenan, no difference could be found when the blend was extruded into a noodle and chopped up using a high-shear mixer (viz. example 10).

### SEM Results

The SEM allows insight into the real structuring. The examples that were selected for analysis on the SEM were a small range of examples representative of the level of oil in a particle, the difference in structurant (alginate vs. carrageenan) and the influence of the drying step.

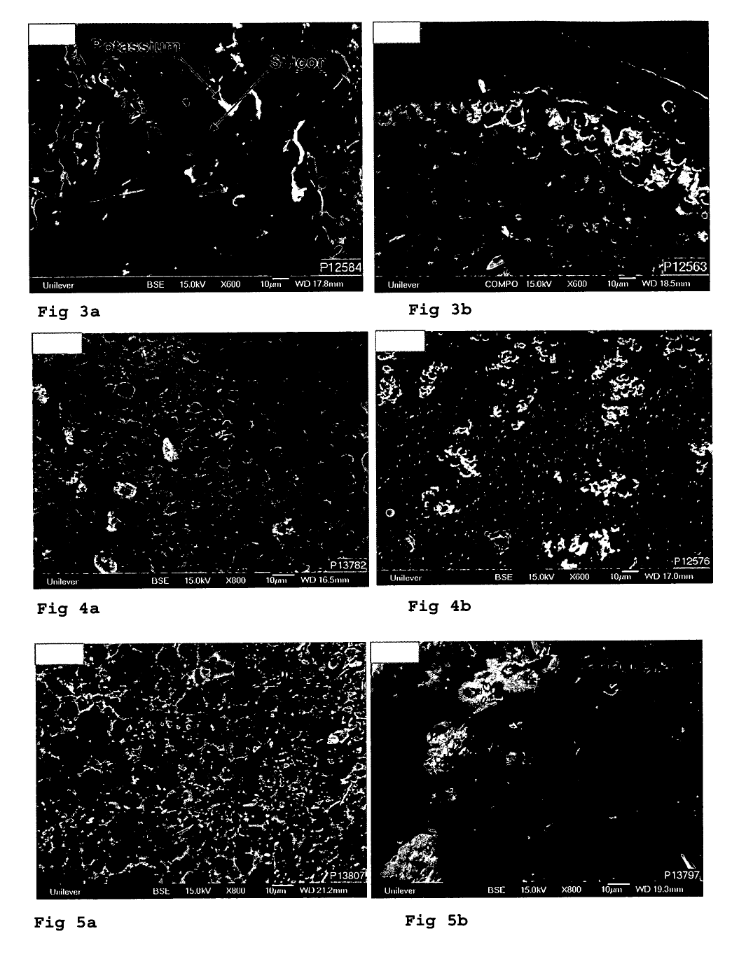

FIGS. 3a and 3b show two photos taken of the same cross linked carrageenan example where the only difference is that one shows a cured but not dried part of a particle (FIG. 3a) and the other shows the structure after drying (FIG. 3b). In these photos, cross-linked carrageenan can be distinguished by the presence of potassium. The SEM shows these as the lit-up lines. The photos show that the silicon droplets are separated from each other by the carrageenan, preventing the silicon droplets agglomerating. FIG. 3b shows that the structure stays intact after drying.

FIGS. 4a and 4b show the differences due to oil loading. Here it can clearly be seen that there is more space between the oil droplets in the example that contains ˜54% oil (FIG. 4a). This is caused by the high level of polysaccharide (˜33%). This is not the case for the high level ˜84% oil loading (FIG. 4b).

FIGS. 5a and 5b shows the differences between carrageenan (TS-C 6244) and alginate (GMB). The major difference is the thick “wall” that can be seen for alginate. The matrix structure seems to be present in alginate as well. The TS-C 6244 example (FIG. 5b) does not show a difference in structure when compared to the X0909 example (FIG. 3b).

### Softness Tests

Ideally, the encapsulated particles should not deliver significantly less softness than the emulsion they were made from. The results from the first softness test are set out in Table 4.

TABLE 4
Paired Comparisons of Softness Monitors

| WASH MATERIAL | PREFERENCE SCORE |
|---|---|
| unencapsulated emulsion | 18 |
| 9% k-carrageenan XO909 grade | 13 |
| 82% oil | |
| 33% k-carrageenan XO909 grade | 12 |
| 55% oil | |
| 8% k-carrageenan TS-C 6244 | 11 |
| 85% oil | |
| 8% alginate GMB grade 75% oil | 7 |
| 21% alginate DH grade 65% oil | 7 |

These examples show parity of the duplex containing kappa carrageenan examples to the original duplex.

Dispersion and softness measurements show no residues of particles when kappa carrageenan concentration is below 10%.

Dispersion and softness measurements show residues of particles for alginate examples as well as kappa carrageenan examples with a concentration greater then 10%.

It can be seen that although the particles did not perform as well as the unencapsulated original emulsion, the kappa carrageenan outperformed the alginate and the particles having the higher oil contents, tested at the same theoretical level of oil in the wash, outperformed those having a lower oil content.

The results from the second test are set out in table 5.

TABLE 5

| PRODUCT | PREFERENCE SCORE |
|---|---|
| Separate rinse conditioner | 42 |
| 04AGT058 emulsion | 17 |
| 04AGT058 beads | 11 |
| Commercial 2 in 1 powder | 3-7 |

Observations from this test indicate that the alginate granules do not dissolve fully, as seen with the dissolution examples on the Malvern. This is probably due to there being insufficient sequestrant to remove the Calcium ions used to bind the alginate. For kappa carrageenan, dissolution is not a problem. Only high levels of polysaccharide left any residues.

The objective of these tests was to see if the encapsulated emulsion delivered the same level of softness as that of the emulsion itself. The slightly lower level of softness when delivered from the particles or granules may be explained by the time needed to dissolve the granule. Delivered softness increases with increase in silicon droplet deposition. The unencapsulated emulsion is released almost immediately at the beginning of the wash. This does not happen for the granule, resulting in less time for the silicon droplets to disperse and deposit.

### Results for Single Emulsions in Kappa Carrageenan

To show that the encapsulation technology may be applied to single, as well as double, emulsions various oils were prepared as oil in water (OIW) single emulsions. The PMC (powder moisture contents) and subsequent oil- and polysaccharide levels of the obtained dried particles are set out in table 6.

The dispersion behaviour of blended, wet and dried particle was measured. The D(v0.5) and D(v0.9) were measured. The results are given in table 7.

TABLE 6
Characteristics of Particles

| Polymer & | | | Polysaccharide | |
|---|---|---|---|---|
| grade | Oil type | Water [%] | [%] | Oil [%] |
| Alginate | | | | |
| GMB | Mineral | 9.1 | 9.1 | 87.8 |
| DH | Mineral | 9.2 | 9.2 | 88.0 |
| kappa | | | | |
| carrageenan | | | | |
| X0909 | Mineral | 2.2 | 9.2 | 88.6 |
| X0909 | MCT | 1.4 | 9.3 | 89.3 |
| X0909 | ExtraSoft | 1.7 | 9.3 | 89.0 |
| X0909 | Sunflower | 2.8 | 9.2 | 88.0 |

Although there is some minor fluctuation between e.g. the blended, wet particle and dried particle, the results, like those seen for the inclusion of the double emulsion, show no differences between the encapsulated emulsion and the released emulsion. Although the alginate examples dispersed

TABLE 7
Results from Dispersion Measurements

| | # | Type | Oil type | Format | State | D_{(v, 0.5)} | D_{(v, 0.9)} |
|---|---|---|---|---|---|---|---|
| Poly- | 1 | X0909 | ExtraSoft | blend | liquid | 9.7 | 18.0 |
| saccharide | 2 | X0909 | ExtraSoft | bead | cured/ | 12.3 | 19.1 |
| kappa | | | | | undried | | |
| carrageenan | 3 | X0909 | ExtraSoft | bead | dried | 9.0 | 18.8 |
| | 4 | X0909 | Mineral | blend | liquid | 11.3 | 14.9 |
| | 5 | X0909 | Mineral | bead | cured/ | 11.0 | 15.7 |
| | | | | | undried | | |
| | 6 | X0909 | Mineral | bead | dried | 12.5 | 18.0 |
| alginate | 7 | GMB | Mineral | blend | liquid | 5.6 | 7.4 |
| | 8 | GMB | Mineral | bead | dried | 4.7 | 18.7* |
| | 9 | DH | Mineral | blend | liquid | 6.5 | 9.1 |
| | 10 | DH | Mineral | bead | cured/ | 9 | 14.5 |
| | | | | | undried | | |
| kappa | 11 | X0909 | MCT | blend | liquid | 7.4 | 9.6 |
| carrageenan | 12 | X0909 | MCT | bead | cured/ | 7.3 | 9.8 |
| | | | | | undried | | |
| | 13 | X0909 | MCT | bead | dried | 7.8 | 11.6 |
| | 14 | X0909 | Sunflower | blend | liquid | 7.9 | 9.8 |
| | 15 | X0909 | Sunflower | bead | cured/ | 7.6 | 9.6 |
| | | | | | undried | | |
| | 16 | X0909 | Sunflower | bead | dried | 8.3 | 11.9 |

*Bead would not dissolve. Citrate was added as sequestrant

the emulsion as well, residues were again found after measurement. In order to see if alginate dispersed the emulsion fully when the particle was fully dissolved, some sodium citrate was added. Sodium citrate functions as a sequestrant and should help to diffuse the Ca²⁺ from the alginate, so that the particle could fully dissolve. This was found to occur.

1. A process for making a dried softening particle with a mean diameter of more than 250 micron and less than 650 micron comprising softening oil emulsion in a polymer matrix, characterised in that the process includes the steps of:
(a) forming a single or double emulsion comprising the softening oil and water,
(b) dispersing the emulsion in a weight excess of polysaccharide solution,
(c) cross-linking or gelling the polysaccharide with an aqueous solution of cations to form the polymer matrix
wherein the temperature is kept below 60° C. during each of steps a, b and c and the polysaccharide is selected from the group comprising kappa carrageenan and alginate, provided that when kappa carrageenan is selected, the cations comprise potassium and when alginate is selected the cations comprise calcium.

2. (canceled)

3. (canceled)

4. (canceled)

5. A process according to claim 1 in which the polysaccharide is kappa carrageenan.

6. A dried softening particle with a mean diameter of more than 250 micron and less than 650 micron and a water content of less than 20% obtainable by the process according to claim 1, comprising at least 50 wt % of a softening oil in a matrix of a reversibly gelled polysaccharide, selected from kappa carrageenan gelled with potassium cations and alginate gelled with calcium cations.

7. A softening particle according to claim 6 in which the matrix material is kappa carrageenan.

8. (canceled)

9. A softening particle according to claim 6 in which the emulsion is a double emulsion.

10. A softening particle according to claim 6 in which the softening oil is an oil grafted onto a cellulose substantive non-hydrolysable polysaccharide, preferably cellulose monoacetate or locust bean gum.

11. A detergent composition in the form of a powder containing 1 to 7% of softening particles made according to the process of claim 1.

12. (canceled)

13. A detergent composition in the form of a tablet containing 1 to 7% of softening particles made according to the process of claim 1.

14. A detergent composition according to claim 6 wherein the softening particles comprise alginate and the composition further comprises a sequestrant and/or builder in an amount effective to reverse the gelling of the alginate on dilution in wash water.

15. Use of an effective amount of a detergent according to claim 1 to soften fabric in the wash.

16. Use according to claim 10 in which the fabric comprises cotton.
